(19) United States
(12) Patent Application Publication
(10) Pub. No.: US 2002/0094307 A1
(43) Pub. Date: Jul. 18, 2002

(54) Apparatus for fumigating germicidal and deodorant agent for an air conditioner container of the agent employed in the apparatus

(76) Inventors: Ji-Moon Chung, Seoul (KR); Jin-Woo Chung, Eumsung-gun (KR); Se-Hwan Ki, Seoul (KR)

Correspondence Address: HARNESS, DICKEY & PIERCE, P.L.C., P.O. BOX 828, BLOOMFIELD HILLS, MI, 48303, US

(21) Appl. No.: 10/036,319

(22) Filed: Dec. 27, 2001

(30) Foreign Application Priority Data
Dec. 28, 2000 (KR) 2000-36806
Aug. 28, 2001 (KR) 2001-26121

(51) Int. Cl. B32B 27/04

(52) U.S. Cl. 422/126

(57) ABSTRACT

Disclosed is an apparatus for fumigating germicidal and deodorant agent used in disinfecting and deodorizing the interior of an air conditioner employed in a building or an automobile. The apparatus has a supporter, on which a container containing the germicidal and deodorant agent is disposed; a heating assembly for heating the container; and a power supply section for applying electric power to the heating heating assembly. The heating assembly comprises a heater housing standing at a central upper portion of the supporter and having an electric terminal through which the electric power is applied from the power supply section, and a PTC heater disposed in the heater housing and being connected with the electric terminal of the heater housing. The power supply section has a timer for cutting off the electric power when preset time has passed after the electric power was started to be supplied through the power supply section. By the apparatus, quantity of generated heat and heat generating time can be easily controlled.

### BACKGROUND OF THE INVENTION

1. Field of the Invention

The present invention relates to an apparatus for fumigating germicidal and deodorant agent used in disinfecting and deodorizing the interior of an air conditioner employed in a building or an automobile.

2. Description of the Prior Art

In an air conditioner utilized in maintaining the interior of a building or an automobile pleasant, various germs and molds propagate and various smelly particles are accumulated. However, it is a cumbersome job to disassemble the air conditioner part by part, in order to eliminate the germs, molds, and smell.

Therefore, developed is an apparatus for fumigating germicidal and deodorant agent, by which the germicidal and deodorant agent is introduced from the exterior to the interior of an air conditioner, so as to eliminate the germs, molds, and smell in the air conditioner.

The above-mentioned apparatus for fumigating germicidal and deodorant agent includes a deodorizer container containing powder of germicidal and deodorant agent, a pyrogen container containing pyrogen, and a reaction container. The deodorizer container is contained in the pyrogen container, and calcium oxide is utilized as the pyrogen.

When the pyrogen container has been inserted in the reaction container after solvent, or water, was put in the reaction container, the water is introduced into the pyrogen container through pores formed at the bottom of the pyrogen container and then reacts with the calcium oxide. The pyrogen container is heated by high temperature heat generated due to the reaction, and the germicidal and deodorant agent in the deodorizer container is vaporized into the atmosphere.

When the air conditioner is operated, the vaporized germicidal and deodorant agent in the atmosphere flows along with indoor air and is introduced into the air conditioner, so as to sterilize germs and molds and eliminate smell in the air conditioner.

However, the conventional apparatus for fumigating germicidal and deodorant agent as described above has the following disadvantages.

First, in the conventional apparatus for fumigating germicidal and deodorant agent, the reaction between the calcium oxide, which is the pyrogen, and the water, which is the solvent, happens in an instant. Therefore, because a large quantity of heat is abruptly generated in very short time, it is impossible to control the quantity of the generated heat and the heat generating time. As a result, a user may get burnt due to a partial overheating when the reaction between the pyrogen and the water occurs.

Further, because the reaction between the pyrogen and the water occurs in very short time, the reaction is frequently ended before all of the germicidal and deodorant agent in the deodorizer container is vaporized, thereby deteriorating the reaction efficiency. Moreover, the deodorizer container once used cannot be reused, thereby causing waste of material.

Furthermore, the calcium oxide used as the pyrogen has a characteristic that it can react with the water very easily. Therefore, when the pyrogen container is not sufficiently airtight, the calcium oxide may be exposed to and may react in advance with water vapor in the atmosphere, so that the calcium oxide may fail to generate sufficient heat due to reduction of its quantity, thereby deteriorating the performance of the apparatus.

### SUMMARY OF THE INVENTION

Accordingly, the present invention has been made to solve the above-mentioned problems occurring in the prior art, and an object of the present invention is to provide an apparatus for fumigating germicidal and deodorant agent for an air conditioner, which can control quantity of generated heat and heat generating time.

It is another object of the present invention to provide an apparatus for fumigating germicidal and deodorant agent for an air conditioner, which can be reused.

In order to accomplish this object, there is provided an apparatus for fumigating germicidal and deodorant agent for an air conditioner, the apparatus comprising: a supporter, on which a container containing the germicidal and deodorant agent is disposed; means for heating the container; and a power supply section for applying electric power to the heating means.

In this case, the heating means may comprise a heater housing standing at a central upper portion of the supporter and having an electric terminal through which the electric power is applied from the power supply section, and a heater disposed in the heater housing and being connected with the electric terminal of the heater housing, the heater being formed of a positive temperature coefficient thermistor.

Otherwise, the heating means may comprise a tie rod extending upward from an upper center portion of the supporter, a heating wire wound around the tie rod in a spiral shape, and a heater housing encasing the tie rod and the heating wire.

It is preferred that the power supply section comprises a timer for cutting off the electric power when preset time has passed after the electric power was started to be supplied through the power supply section, or a bimetal switch for cutting off the electric power when the container is heated to a temperature higher than a preset temperature. It is also preferred that the power supply section further comprises an indication lamp disposed at one side portion of the supporter, which is turned on when the electric power is applied through the power supply section.

Preferably, the apparatus for fumigating germicidal and deodorant agent may further comprise a protection tube extending upward from a circumference of the supporter to a level higher than the container, so as to prevent a user from being burnt by the container.

Meanwhile, the present invention also provides a container for germicidal and deodorant agent employed in an apparatus for fumigating germicidal and deodorant agent as described above. The apparatus comprises: an inner case containing the germicidal and deodorant agent, the inner case being shaped like a cylinder whose upper end is open and having a receiving recess caved inward from a lower end of the inner case, so that a heating assembly of the apparatus can be disposed in the receiving recess; and an outer case made from material having a low thermal conductivity, the outer case being shaped like a cylinder whose lower end is open, so that the inner case can be fitted in the outer case, the outer case having at least an exhaust pore formed through an upper surface of the outer case, through which vaporized germicidal and deodorant agent is exhausted, the exhaust pore being blocked by a sealing film made from material melted by heat.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of an apparatus for fumigating germicidal and deodorant agent for an air conditioner according to an embodiment of the present invention;

FIG. 2 is a sectional view of a heating assembly employed in the apparatus shown in FIG. 1;

FIGS. 3 and 4 are sectional views of apparatuses for fumigating germicidal and deodorant agent for an air conditioner according to other embodiments of the present invention.

### DETAILED DESCRIPTION OF THE PREFERRED EMBODIMENTS

Hereinafter, several preferred embodiments of the present invention will be described with reference to the accompanying drawings.

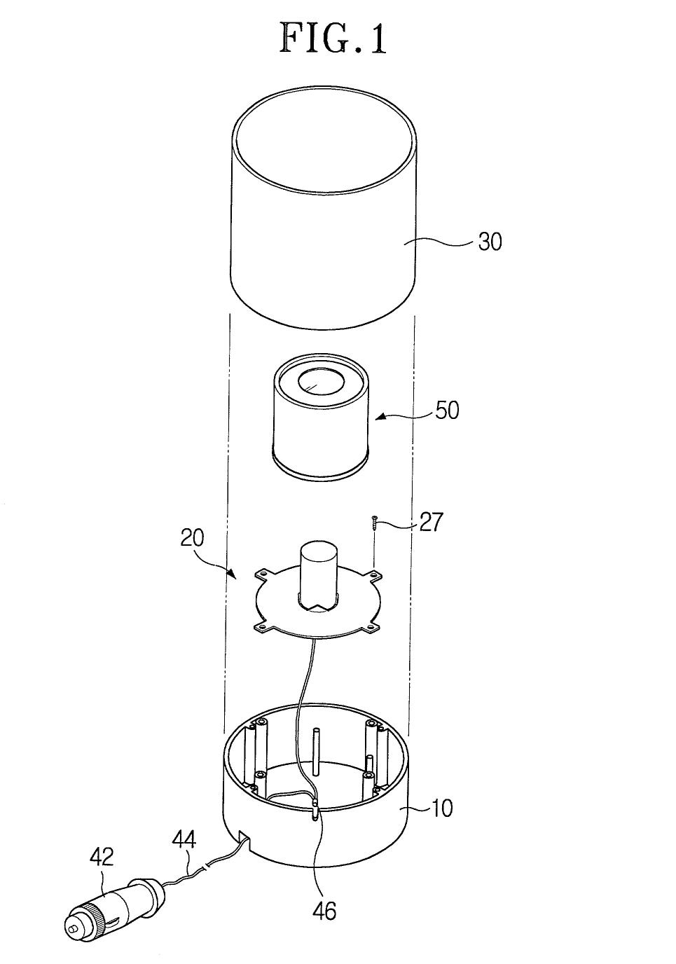

FIG. 1 is an exploded perspective view of an apparatus for fumigating germicidal and deodorant agent for an air conditioner according to an embodiment of the present invention.

As shown, the apparatus for fumigating germicidal and deodorant agent for an air conditioner according to an embodiment of the present invention includes a supporter 10 having a cylindrical shape and a heating assembly 20 disposed at the center of an upper surface of the supporter 10. A container 50 for germicidal and deodorant agent (hereinafter, referred to as “container”) is fitted around the heating assembly 20, so that it is disposed on the upper surface of the supporter 10. It is preferred that a protection tube 30 extends upward from the circumference of the supporter 10 to a level higher than the container 50, so as to prevent a user from being burnt by the container 50 fitted around the heating assembly 20. The protection tube 30 has a plurality of assembling portions formed at a lower end of the protection tube 30, which are fixed to the upper surface of the supporter 10 by assembling means such as screws.

The heating assembly 20 has a holding bracket 26 fixed to a lower end of the heating assembly 20. The holding bracket 26 is fixed to the upper surface of the supporter 10 by screws 27, so that the heating assembly 20 is fixedly held at a central upper portion of the supporter 10.

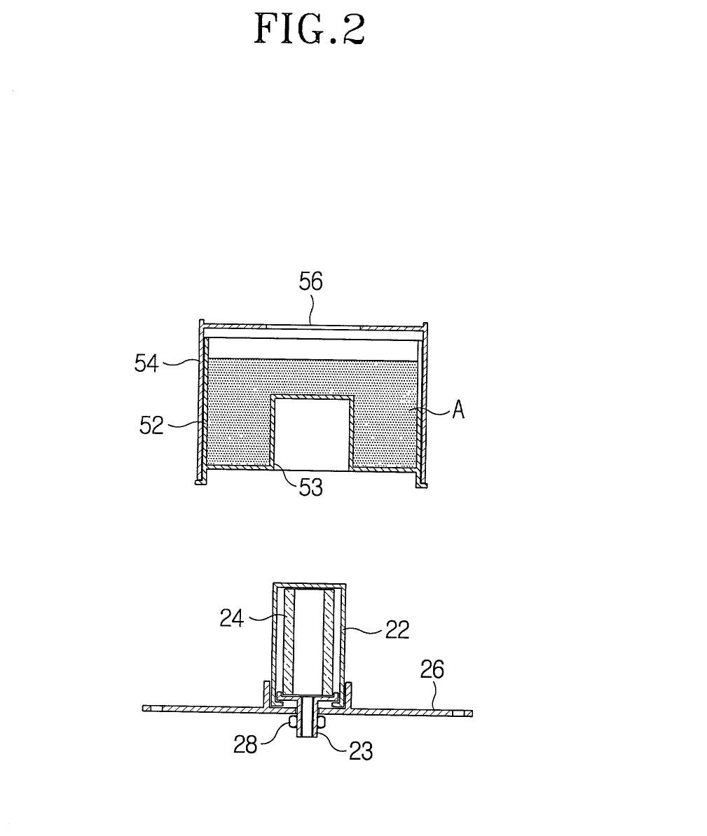

In more detailed description, as shown in FIG. 2, the heating assembly 20 includes a heater housing 22 containing a heater 24 formed of positive temperature coefficient thermistor (hereinafter, referred to as “PTC heater”). The heater housing 22 has a downward protuberance 23 formed at a lower surface of the heater housing 22, which extends downward through the holding bracket 26 to be fixed by a bolt and nut set 28, so that the heater housing 22 is fixed to the holding bracket 26. The bottom of the heater housing 22 is separated from the other portion of the heater housing 22 and is made from conductive material. The bottom of the heater housing 22 is connected with an electric wire of a power supply section, which will be described later, so as to function as an electric terminal. The PTC heater 24 has a cylindrical shape, and is received in the heater housing 22 in such a manner as that the lower end of the PTC heater 24 is in contact with the bottom of the heater housing 22, that is, the electric terminal. The heater housing 22 is made from material having a high thermal conductivity, such as copper, aluminum, and steel.

In the meantime, the power supply section includes an electric power plug 42 and an electric wire 44 whose end is connected to the electric terminal of the heater housing 22. When the electric power plug 42 is connected with an electric power source, the PTC heater 24 connected with the electric power source generates heat, which is then transmitted through22 to the container 50, thereby vaporizing the germicidal and deodorant agent in the container 50. Although FIG. 1 shows the electric power plug 42 connected with a cigar jack of an automobile, the apparatus of the present invention may employ a plug inserted in a household plug socket, instead of the cigar jack plug. When a plug inserted in the household plug socket is employed, the power supply section includes a transformer for converting alternating electric current to direct electric current.

Further, an indication lamp 46 is disposed at one side portion of the supporter 10, so as to indicate that the apparatus is in operation when electric power is applied through the power supply section. In this case, it is preferred that the indication lamp 46 is a light emitting diode (LED) lamp.

Further, the apparatus includes a timer (not shown) for controlling operation of the apparatus. The timer cuts off the electric power when preset time has passed after electric power supply through the power supply section was initiated. Therefore, it is not necessary for a user to check the operation time, and the apparatus is automatically prevented from being overheated due to an operation for long time.

Instead of the timer, the apparatus may include a bimetal switch (not shown) capable of switching the power supply according to the temperature. In this case, the germicidal and deodorant agent can be vaporized at a constant speed, while the container 50 is not overheated but is maintained at a constant temperature.

Of course, it is preferred that the apparatus is provided with both the timer for controlling the operation time and the bimetal switch for preventing the apparatus from being overheated. Although the timer and the bimetal switch are not shown in the drawings, it can be easily understood by those related to the art that the power supply section of the apparatus may include the timer or the bimetal switch.

Meanwhile, the container 50 employed in the apparatus of the present invention includes an inner case 52 and an outer case 54. The inner case 52 is shaped like a cylinder whose upper end is open, and has a receiving recess 53 caved inward from the lower end of the inner case 52. The receiving recess 53 has an inner diameter slightly larger than the outer diameter of the heater housing 22 of the heating assembly 20. The inner case 52 contains the germicidal and deodorant agent powder A. The inner case 52 is made from material having a high thermal conductivity, such as iron, steel, zinc-plated steel plate, and aluminum.

The outer case 54 is shaped like a cylinder whose lower end is open, and has an inner diameter equal to the outer diameter of the inner case 52, so that the inner case 52 cannot be separated out of the outer case 54 well after the inner case 52 is fitted in the outer case 54. It is preferred that the outer case 54 is made from material having a low thermal conductivity, such as paper, so as to prevent a user from being burnt by remaining heat when the container 50 is wasted after the operation of the apparatus is completed.

Further, through the upper surface of the outer case 54 is formed at least an exhaust pore, through which the vaporized germicidal and deodorant agent is exhausted by the operation of the apparatus. It is preferred that the exhaust pore is blocked by a sealing film 56, so as to prevent the germicidal and deodorant agent from being discharged or moisture from coming into the outer case 54 through the exhaust pore when the apparatus is not operated. It is more preferred that the sealing film 56 is made from material, which is easily melted by heat, such as polyethylene, so that it is not necessary for a user to do a separate labor of eliminating the sealing film 56 when the apparatus is operated.

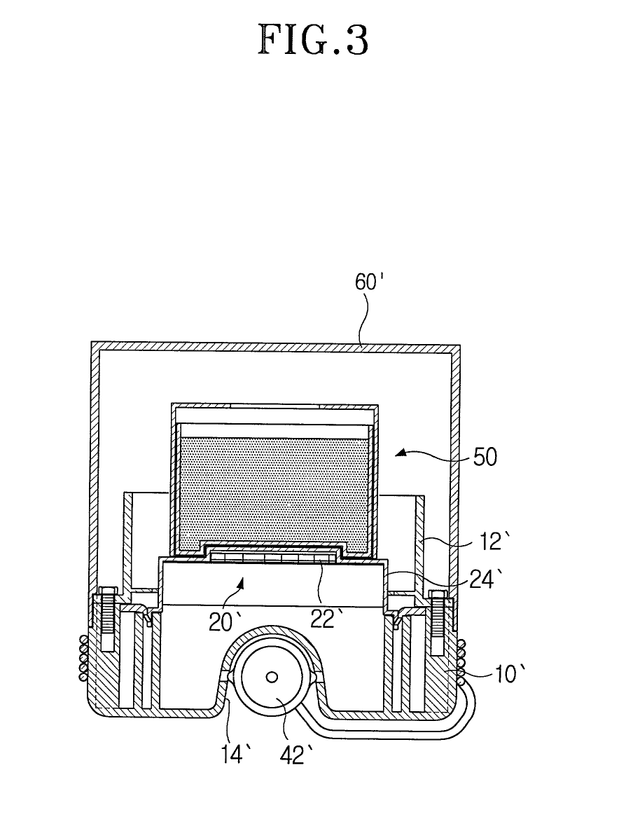

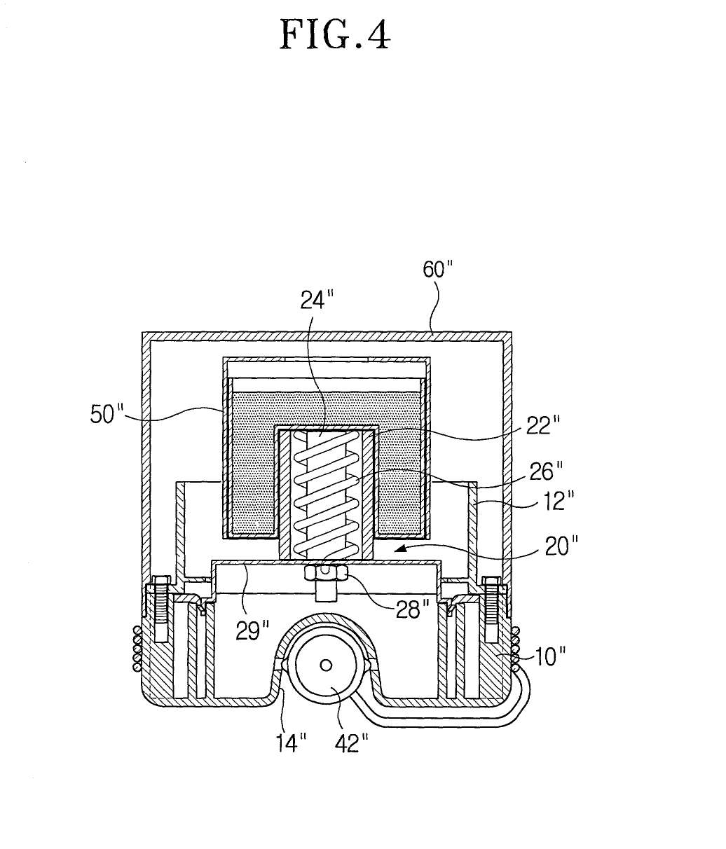

FIGS. 3 and 4 show apparatuses for fumigating germicidal and deodorant agent for an air conditioner according to other embodiments of the present invention.

In the apparatus shown in FIG. 3, the heating assembly 20′ includes a PTC heater 22′ shaped like a flat plate and a cover 24′ covering over the PTC heater 22′. The PTC heater 22′ has a shape of a circular or rectangular thin plate, so that the height of the heating assembly 22′ is reduced. Therefore, a holding wall 12′ is disposed around the container 50, so as to prevent the container from coming out of its original position due to external impact while the apparatus is in operation.

In the apparatus shown in FIG. 4, the heating assembly 20″ includes a holding bracket 29″, a tie rod 24″ extending through the holding bracket 29″ and fixed by means of a nut 28′, a heating wire 26″ wound around the tie rod 24″, and a cylindrical heater housing 22″ encasing the tie rod 24″ with the heating wire 26″. As the heating wire 26″, nickel-chrome wire or iron-chrome wire is employed. The heater housing is made from material having a high thermal conductivity such as copper, aluminum, and steel.

Further, the apparatuses shown in FIGS. 3 and 4 include covers 60′ and 60″ for preventing the container 50 and the holding walls 12′ and 12″ from being exposed to the exterior and preventing a user from being burnt by the container 50. Pores (not shown) are formed through the covers 60′ and 60″, so as to enable the vaporized germicidal and deodorant agent to be discharged out of the covers.

Moreover, in the apparatuses shown in FIGS. 3 and 4, the electric power plugs 42′ and 42″ are received in plug recesses 14′ and 14″ formed at lower surfaces of the supporters 10′ and 10″, and the electric wires 44′ and 44″ are wound around the supporters 10′ and 10″.

As described above, in an apparatus for fumigating germicidal and deodorant agent for an air conditioner according to the present invention, the germicidal and deodorant agent is fumigated by means of a heating wire or a PTC heater, so that the quantity of generated heat and the heat generating time can be easily controlled. As a result, the germicidal and deodorant agent can be uniformly fumigated without being partially overheated, so as to prevent material for the germicidal and deodorant agent from being wasted and prevent a user from being burnt. Furthermore, the apparatus can be repeatedly used only by replacing the container for germicidal and deodorant agent.

Although several preferred embodiments of the present invention have been described for illustrative purposes, those skilled in the art will appreciate that various modifications, additions and substitutions are possible, without departing from the scope and spirit of the invention as disclosed in the accompanying claims.

The entire disclosures of Korean patent application Nos. 2000-36806 filed Dec. 28, 2000 and 2001-26121 filed Aug. 28, 2001 are hereby incorporated by reference.

What is claimed is:

1. An apparatus for fumigating germicidal and deodorant agent for an air conditioner, the apparatus comprising:
a supporter, on which a container containing the germicidal and deodorant agent is disposed;
means for heating the container; and
a power supply section for applying electric power to the heating means.

2. An apparatus for fumigating germicidal and deodorant agent as claimed in claim 1, wherein the heating means comprises a heater housing standing at a central upper portion of the supporter and having an electric terminal through which the electric power is applied from the power supply section, and a heater disposed in the heater housing and being connected with the electric terminal of the heater housing, the heater being formed of a positive temperature coefficient thermistor.

3. An apparatus for fumigating germicidal and deodorant agent as claimed in claim 1, wherein the heating means comprises a tie rod extending upward from an upper center portion of the supporter, a heating wire wound around the tie rod in a spiral shape, and a heater housing encasing the tie rod and the heating wire.

4. An apparatus for fumigating germicidal and deodorant agent as claimed in claim 1, wherein the power supply section comprises a timer for cutting off the electric power when preset time has passed after the electric power was started to be supplied through the power supply section.

5. An apparatus for fumigating germicidal and deodorant agent as claimed in claim 1, wherein the power supply section comprises a bimetal switch for cutting off the electric power when said heating means or the container is heated to a temperature higher than a preset temperature.

6. An apparatus for fumigating germicidal and deodorant agent as claimed in claim 1, wherein the power supply section further comprises an indication lamp disposed at one side portion of the supporter, which is turned on when the electric power is applied through the power supply section.

7. An apparatus for fumigating germicidal and deodorant agent as claimed in claim 1, the apparatus further comprising a protection tube extending upward from a circumference of the supporter to a level higher than the container, so as to prevent a user from being burnt by the container.

8. An apparatus for fumigating germicidal and deodorant agent for an air conditioner, the apparatus comprising:
a supporter, on which a container containing the germicidal and deodorant agent is disposed;
a tie rod extending upward from an upper center portion of the supporter;
a heating wire wound around the tie rod in a spiral shape;
a heater housing encasing the tie rod and the heating wire, the heater housing being inserted in a receiving recess formed at a lower surface of the heater housing;
a protection tube extending upward from a circumference of the supporter to a level higher than the container, so as to prevent a user from being burnt by the container;
an electric power plug connected with the heating wire through an electric wire, so as to apply electric power to the heating wire;
a timer for cutting off the electric power when preset time has passed after the electric power was started to be supplied through the power supply section; and
an indication lamp disposed at one side portion of the supporter, which is turned on when the electric power is applied through the power supply section.

9. A container for germicidal and deodorant agent employed in an apparatus of claim 8, the container comprising:
an inner case containing the germicidal and deodorant agent, the inner case being shaped like a cylinder whose upper end is open and having a receiving recess caved inward from a lower end of the inner case, so that a heating assembly of the apparatus can be disposed in the receiving recess; and
an outer case made from material having a low thermal conductivity, the outer case being shaped like a cylinder whose lower end is open, so that the inner case can be fitted in the outer case, the outer case having at least an exhaust pore formed through an upper surface of the outer case, through which vaporized germicidal and deodorant agent is exhausted, the exhaust pore being blocked by a sealing film made from material melted by heat.
